(19) United States
(12) Patent Application Publication
(10) Pub. No.: US 2010/0101372 A1
(43) Pub. Date: Apr. 29, 2010

(54) SUCTION JAR OPENER

(75) Inventors: Justin Bagley, Seattle, WA (US); Lawrence M. Hauser, Auburn, WA (US)

Correspondence Address: BLACK LOWE & GRAHAM, PLLC, 701 FIFTH AVENUE, SUITE 4800, SEATTLE, WA, 98104, US

(73) Assignee: PROGRESSIVE INTERNATIONAL CORPORATION, Kent, WA (US)

(21) Appl. No.: 12/606,938

(22) Filed: Oct. 27, 2009

Related U.S. Application Data
(60) Provisional application No. 61/109,100, filed on Oct. 28, 2008.

(51) Int. Cl. B67B 7/14; B67B 7/18

(52) U.S. Cl. 81/3.42; 81/3.55

(57) ABSTRACT

A suction jar opener includes a suction cup or other vacuum-creating mechanism secured to a handle. The suction cup forms a grip between a lid of a jar and the suction cup, allowing the handle to be rotated to remove the lid. The handle is preferably pivotable between a position that releases the suction and a position that causes a suction and is radially extending away from the jar.

### PRIORITY CLAIM

This application claims the benefit of prior U.S. provisional application Ser. No. 61/109,100, filed Oct. 28, 2008.

### FIELD OF THE INVENTION

This invention relates generally to jar opening devices, particularly including devices using a suction cup to facilitate a grip with a jar lid.

### BACKGROUND OF THE INVENTION

In many cases it can be extremely difficult to remove a lid from a jar. If the seal is particularly strong, many individuals may lack the hand strength required to twist the lid in order to remove it from the jar. There are many products available to improve the grip, such as sections of rubber or other non-skid materials intended to prevent hands from slipping from the lid as it is twisted. Many people also use tools to pry the lid away from the jar along the rim, but using such devices can deform the lid and thereby prevent the lid from forming an effective seal when the lid is replaced on the jar.

### SUMMARY OF THE INVENTION

In a preferred version of the invention, the device includes a suction cup or other vacuum-creating mechanism secured to a handle. The suction cup forms a grip between the lid and the suction cup, allowing the handle to be rotated to remove the lid. The handle is preferably pivotable between a position axially aligned with the jar and a position radially extending away from the jar or 90 degrees away from the axially aligned position. Additional features provided in certain examples of the invention are described further below.

### BRIEF DESCRIPTION OF THE DRAWINGS

FIG. 1 is a perspective view of a preferred suction jar opener.

FIG. 2 is a side view of a preferred suction jar opener.

FIG. 3 is a top view of a preferred suction jar opener.

FIG. 4 is a bottom view of a preferred suction jar opener.

FIG. 5 is an exploded view of a preferred suction jar opener

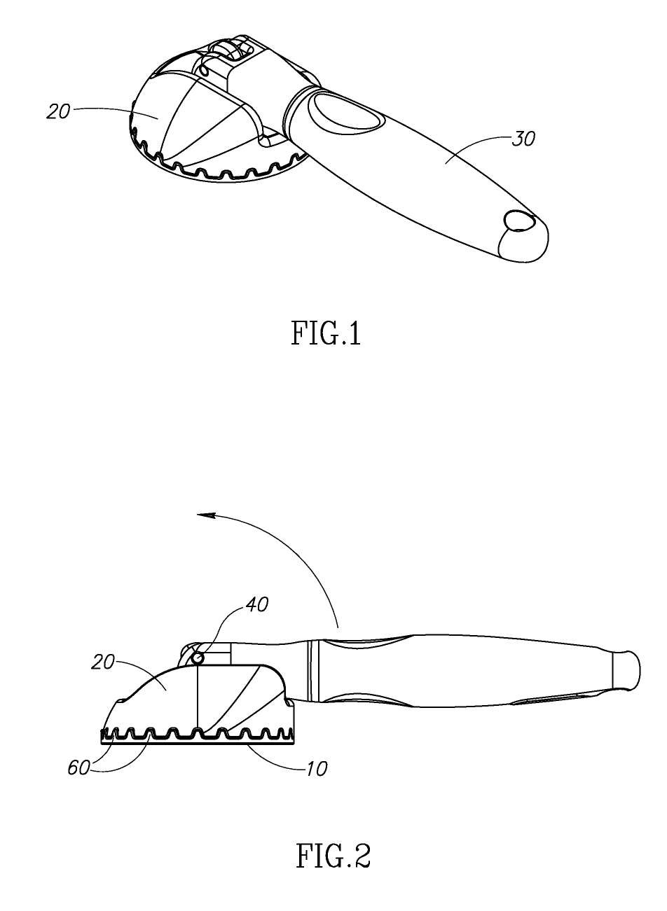

### DETAILED DESCRIPTION OF THE PREFERRED EMBODIMENT

A preferred example of the suction jar opener is shown in figures. As illustrated, the opener includes a suction cup 10 secured to the bottom of a tool head 20. The tool head 20 is pivotally attached to a handle 30 at a pivot point 40. The handle 30 is pivotable between a first position as shown in for example in FIG. 2 in which the handle extends radially away from the substantially circular suction cup and forms an axis generally parallel to a plane defined by the suction cup, and a second position (not shown) in which the handle is substantially axially located over the center of the suction cup. Thus, in such a version, the handle is pivotable through an angle of about 90 degrees between the first position and the second position. The handle may also be pivotable through a range that extends approximately 180 degrees or more. In such a case, the handle is movable from a first position substantially parallel with the suction cup as shown in FIG. 2 and a second position in which the distal end of the handle points in a position generally opposite that of the first position such that the handle has pivoted along a 180 degree arc.

The top of the tool head includes a channel 22 that extends diametrically across the majority of the tool head. The channel is sized and configured to receive the proximal end of the handle, thereby allowing the handle to pivot through the channel as described above. A stem 24 extends upwardly from the tool head and is received within a pair of prongs 43, 44 formed in the proximal end of the handle, with an axle extending through holes 45 formed in the stem and prongs in order to pivotally secure the handle to the stem and the tool head. Note that in alternate embodiments the prong and stem configurations of the handle and stem may be reversed, or yet other structures may be used to pivotally secure the handle to the tool head.

The handle further includes a top side 41 and a bottom side 42, as oriented in the figures in which the handle is parallel with a planed defined by the suction cup. In this configuration, the top side of the handle faces away from the suction cup when the handle is in the first position. The holes 45 formed in the prongs are offset and located relatively closer to the top side of the handle 41 than the bottom side of the handle 42. Likewise, the holes 45 are relatively closer to the termination of the proximal end of the handle than to the bottom side of the handle. The handle, channel, and stem are also sized and configured such that the proximal end of the handle is generally close to or in contact with the bottom of the channel.

Accordingly, the offset nature of the holes in the handle allows the proximal end of the handle to act as a cam. When the handle is pivoted to a position as shown in the figures in which the hole is located in a position on the handle that is relatively distant from the bottom of the channel, the bottom portion 42 of the handle engages the bottom portion of the channel 22 in order to urge the stem upward. But when the handle is oriented in a second position, for example in which the handle is rotated upward and through an arc of 180 degrees (in the direction of the arrow in FIG. 2) so that the distal end of the handle is pointing diametrically opposite the position as shown in FIG. 2, the hole becomes closer to the bottom of the channel 22 and the stem is extended downward. The placement of the holes with respect to the distance from the proximal end further defines the position of the stem during the rotational movement of the handle and therefore the cam action of the handle. Thus, depending on the placement of the holes, the second position may be one in which the handle is extending vertically, generally axial with the axis defined through the stem and rotated approximately 90 degrees from the first position. In the version as shown, the proximal end of the handle is also curved from the top end toward the bottom end, allowing for a smooth cam surface as the handle is pivoted and the stem is urged upward or downward (depending on the pivoting direction).

The stem 24 is secured to a plate 25. In one version, the plate is integrally formed with the stem and is configured as a circular plate that is orthogonally oriented with respect to the stem. The plate and stem are connected to the tool head 20 such that the stem extends through a hole in the tool head, trapping the plate below the top surface of the tool head.

The plate 25 is also secured to a top surface of the suction cup, substantially at the center of the suction cup. The suction cup is formed from a resilient or flexible material. Consequently, the upward and downward movement of the stem, as caused by the pivoting handle and cam action as described above, causes the plate and therefore the suction cup to move upward and downward as well. The plate 25 is sized such that it is smaller in diameter than the suction cup and therefore an upward movement of the suction cup causes an upward movement of the center of the suction cup but little or no upward movement about the perimeter.

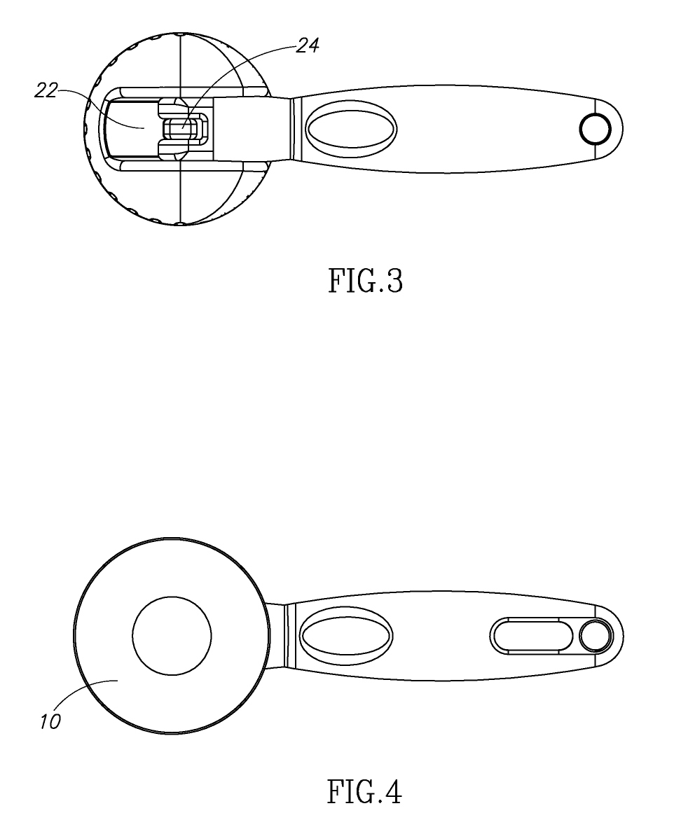

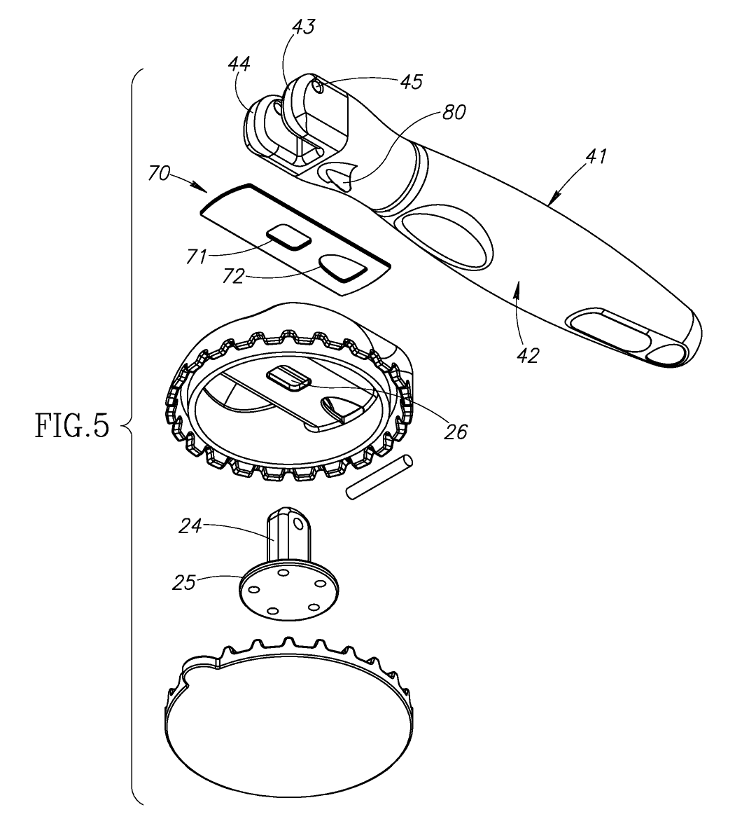

In the version as shown, the tool head 20 is substantially circular as viewed from the top in FIG. 3. The suction cup 10 is also generally circular and is secured to a lower surface of the tool head (via the plate as described above) so that at least a portion of the suction cup extends below the lower surface of the tool head a sufficient distance to allow the suction cup to contact a lid of a jar to be opened. In the example as shown, the suction cup is circular and sized and shaped to fit within the perimeter of the tool head. In other examples, the suction cup may be shallower or deeper than the version as illustrated. Likewise, in other examples the suction cup may employ additional electrical or mechanical levers to enhance the degree of suction and therefore the force between the jar and the lid. In addition, the suction cup need not be “cup-shaped” in order to serve as a suction cup, particularly because the upward movement of the stem and plate as described above will create a cup shape. Thus, the term “suction cup” includes a resilient member as illustrated that is capable of being moved between somewhat flat and somewhat concave positions.

As shown, a lower perimeter of the tool head 20 includes a plurality of arches formed in the tool head, with the arches receiving one of a corresponding plurality of teeth 60 formed in the perimeter of the suction cup. In one example, the teeth extend substantially around the entire perimeter. When the tool head is pressed against the lid of a jar to create suction, the teeth and arches interact to prevent rotation of the tool head with respect to the suction cup when the device is being used to remove a lid.

In one version, the tool head is made from nylon, but it may be formed from other plastics, metals, wood, or other materials. The suction cup is preferably formed from synthetic rubber, TPE, or other suitable resilient materials.

In some examples of the invention, the handle includes a plastic-piercing tooth 80. The tooth extends away from either the top or bottom surface of the handle, and includes a relatively sharp point. The tooth is useful for piercing plastic security seals that are sometimes provided around the lid of a jar.

In the version as shown, the bottom of the channel 22 includes a metal plate 70 that is secured within the channel. The plate provides reinforcement for the cam operation of the handle, as described above. The plate includes a first hole 71 that receives the stem, and a second hole 72 that provides a well for receiving the plastic-piercing tooth 80 when the handle is pivoted into a position in which the tooth is adjacent the bottom of the channel.

In use, the handle is pivoted such that it is in a position with the pivot point 40 relatively closer to the bottom of the channel, thereby allowing the stem, plate, and suction cup to be in a downward orientation. The device is placed in position with the suction cup on top of a lid. The handle is then rotated to a second position in order to urge the stem, plunger, and central portion of the suction cup upward, thereby creating suction between the suction cup and the lid. The amount of rotation necessary may vary, and therefore the second position may be 90 degrees or more preferably about 180 degrees of pivotal movement with respect to the first position. Thus, in some versions the first position is one in which the handle is substantially co-axial with the center of the suction cup, while in other versions the first position may be rotated such that it is parallel to the plane of the suction cup. In the second position, a tight seal should be formed between the lid and the suction cup.

Once a tight seal has been formed, the handle is then rotated in a direction that will turn the lid with respect to the jar in order to remove the lid from the jar.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A suction jar opener, comprising:
a tool head having an upper side and a lower side;
a suction cup attached to the lower side of the tool head, the suction cup having a center and a perimeter and being formed from a resilient material;
a handle having a proximal end and a distal end, the proximal end of the handle being pivotally connected to the tool head and mechanically linked to the suction cup;
whereby the handle is pivotally moveable between a first position in which the center of the suction cup is moved toward the upper side of the tool head to impart a generally concave shape upon the suction cup, and a second position in which the center of the suction cup is moved away from the upper side of the tool head to impart a relatively flatter shape upon the suction cup.

2. The suction jar opener of claim 1, further comprising a stem having a first end and a second end, the first end being secured to the proximal end of the handle and the second end being secured to the suction cup.

3. The suction jar opener of claim 2, wherein the stem further comprises a plate at the second end, the plate being secured to the suction cup.

4. The suction jar opener of claim 2, wherein the suction cup defines a plane and the stem defines an axis generally orthogonal to the plane, the first position of the handle being substantially parallel to the plane and the second position of the handle being substantially parallel to the axis.

5. The suction jar opener of claim 2, wherein the suction cup defines a plane and the stem defines an axis generally orthogonal to the plane, the first position of the handle being substantially parallel to the plane such that the distal end of the handle extends radially away from the axis in a first direction, and the second position of the handle being substantially parallel to the plane such that the distal end of the handle extends radially away from the axis in a second direction.

6. The suction jar opener of claim 2, wherein the proximal end of the handle further comprises a top side facing away from the tool head when the handle is in the first position, a bottom side facing toward the tool head when the handle is in the first position, and a terminal end at a tip of the proximal end, the handle further comprising a pivot axis formed on the proximal end for pivotally securing the handle to the stem, the pivot axis being offset such that it is relatively closer to the top side than to the bottom side.

7. The suction jar opener of claim 6, wherein the pivot axis is further relatively closer to the terminal end than to the bottom side.

8. The suction jar opener of claim 7, wherein the handle further comprises a pair of prongs formed on the proximal end, the pivot axis being defined by a pair of bores formed on the pair of prongs and a pin carried by the stem and secured with the bores.

9. The suction jar opener of claim 7, further comprising a reinforcement plate secured to the tool head where by the proximal end of the handle engages the reinforcement plate during pivotal movement of the handle.

10. The suction jar opener of claim 7, wherein the perimeter of the suction cup comprises a plurality of ridges and the perimeter of the tool head comprises a complementary plurality of arches, the ridges and arches cooperating to prevent rotational movement of the suction cup relative to the tool head.

11. The suction jar opener of claim 2 wherein the suction cup comprises one or more first vertical surfaces and the tool head comprises one or more second vertical surfaces, the first vertical surfaces and the second vertical surfaces engaging one another and cooperating to prevent rotational movement of the suction cup relative to the tool head.

12. A suction jar opener, comprising:
a tool head having an upper side and a lower side;
a suction cup being attached to the lower side of the tool head, the suction cup having a center and a perimeter and being formed from a resilient material, the suction cup further being moveable between a concave position and a relatively flat position;
a handle having a proximal end and a distal end, the proximal end of the handle being connected to the tool head, the handle further being generally parallel to a plane defined by the suction cup when the suction cup is in the concave position; and
a means for moving the suction cup between the concave position and the relatively flat position, the means for moving the suction cup being effected by movement of the handle with respect to the tool head;
whereby the handle is moveable between a first position in which the center of the suction cup is moved toward the upper side of the tool head to impart a generally concave shape upon the suction cup, and a second position in which the center of the suction cup is moved away from the upper side of the tool head to impart a relatively flatter shape upon the suction cup.

13. The suction jar opener of claim 12, wherein the second position of the handle is substantially perpendicular to the plane.

14. The suction jar opener of claim 12, wherein the second position of the handle is substantially parallel to the plane.

15. The suction jar opener of claim 12, wherein the means for moving the suction cup comprises a stem having a first end and a second end and a plate secured on the second end, the first end being secured to the proximal end of the handle and the second end being secured to the suction cup.

16. The suction jar opener of claim 15, wherein the proximal end of the handle further comprises a top side facing away from the tool head when the handle is in the first position, a bottom side facing toward the tool head when the handle is in the first position, and a terminal end at a tip of the proximal end, the handle further comprising a pivot axis formed on the proximal end for pivotally securing the handle to the stem, the pivot axis being offset such that it is relatively closer to the top side than to the bottom side.

17. The suction jar opener of claim 15, wherein the proximal end of the handle further comprises a top side facing away from the tool head when the handle is in the first position, a bottom side facing toward the tool head when the handle is in the first position, and a terminal end at a tip of the proximal end, the handle further comprising a pivot axis formed on the proximal end for pivotally securing the handle to the stem, the pivot axis being offset such that it is relatively closer to the terminal end than to the bottom side.

18. The suction jar opener of claim 12, further comprising a reinforcement plate secured to the tool head where by the proximal end of the handle engages the reinforcement plate.

19. The suction jar opener of claim 12, wherein the tool head further comprises a channel formed on the tool head, the channel receiving the proximal end of the handle.

20. The suction jar opener of claim 12 wherein the suction cup comprises one or more first vertical surfaces and the tool head comprises one or more second vertical surfaces, the first vertical surfaces and the second vertical surfaces engaging one another and cooperating to prevent rotational movement of the suction cup relative to the tool head.
